(19) United States
(12) Patent Application Publication
(10) Pub. No.: US 2026/0153478 A1
(43) Pub. Date: Jun. 4, 2026

(54) METHOD OF OPERATING A FLAME IONIZATION DETECTOR

(71) Applicant: Linde GmbH, Pullach (DE)

(72) Inventor: Wilhelm BAYERL, Pullach (DE)

(21) Appl. No.: 18/686,297

(22) PCT Filed: Aug. 12, 2022
(86) PCT No.: PCT/EP2022/025371

§ 371 Date: Feb. 23, 2024

(30) Foreign Application Priority Data
Aug. 30, 2021 (EP) 21020431.9

(51) Int. Cl. G01N 27/626; G01N 30/68

(52) U.S. Cl. CPC G01N 27/626; G01N 30/68

(57) ABSTRACT

The present invention relates to a method of operating a flame ionization detector comprising providing a hydrogen containing fuel gas, providing an oxygen containing oxidizing gas, burning the fuel gas with the oxidizing gas to produce a flame, providing a sample gas to the flame to produce an at least partially ionized sample gas, wherein the sample gas contains at least one organic compound and a carrier gas, and measuring a current induced by the at least partially ionized sample gas in an electrode of the flame ionization detector. It is provided that the oxidizing gas comprises oxygen in an amount of 50 to 90 vol % of the oxidizing gas and helium in an amount of at least 10 vol % of the oxidizing gas. An arrangement comprising a flame ionization detector and a gas mixture for use in a flame ionization detector are also part of the invention.

The present invention relates to a method of operating a flame ionization detector, to an arrangement comprising a flame ionization detector, and to a gas mixture for use in a flame ionization detector according to the preambles of the independent claims.

### BACKGROUND OF THE INVENTION

Flame ionization detectors (FIDs) are known since the late 1950s as detectors used in connection with gas chromatographs (GC), for example. FIDs are also typically used in so-called total hydrocarbon analyzers, i.e. instruments which are typically used for monitoring hydrocarbon contaminations in high purity bulk gases or in emission control systems.

The operating principle of the FID relies on the detection of ions, which are formed during combustion of organic compounds in a flame, typically a hydrogen flame. The amount of generated ions is proportional to the concentration of the organic species to be analysed from a sample gas (e.g. an effluent from GC).

These ions are detected by two electrodes between which a potential difference is provided. The cathode is typically provided at a nozzle head at which the flame is produced. The counter electrode (i.e. anode) is positioned above the flame. In conventional FIDs, the anode is provided as a tubular electrode, also known as collector plate. The cations formed in the flame are attracted to the collector plate and upon hitting the plate, induce a current. This induced current roughly corresponds to the proportion of ionized carbon atoms in the flame. Therefore, the detector is sensitive to the mass of volatile organic matter within the sample gas.

Typically, the flame used for producing the ions to be detected is generated by burning hydrogen in purified or synthetic air, the so-called oxidizing gas, which has to be free of hydrocarbons and other volatile organics in order to avoid background noise. It is an object of the present invention to improve known flame ionization detectors and their operation, particularly in view of sensitivity. Examples for such kind of gas mixtures for FIDs are described e.g. in US2010/0310419.

### DISCLOSURE OF THE INVENTION

According to the present invention, a method of operating a flame ionization detector with the features set out in the independent claim is proposed. Advantageous embodiments and additional features are subject-matter of the dependent claims and the following description.

### Features of the Invention

According to the invention, a method of operating a flame ionization detector (again shortly referred to as FID hereinbelow) comprises providing a hydrogen containing fuel gas and an oxygen containing oxidizing gas and burning the fuel gas with the oxidizing gas, producing a flame. The method further comprises providing a sample gas containing at least one organic compound and a carrier gas to the flame, producing and at least partially ionized sample gas, and measuring a current induced by the at least partially ionized sample gas in an electrode of the FID.

According to the invention, the oxidizing gas comprises oxygen in an amount corresponding to 50 to 90 vol % of the oxidizing gas and helium in an amount corresponding to at least 10 vol % of the oxidizing gas.

As was surprisingly found by the present inventors, using the oxidizing gas in a composition as proposed by the present invention results in a decrease of the limit of detection (LoD) for certain hydrocarbons by a factor of 3 to 10, thus drastically improving sensitivity in comparison to conventional methods of operating FIDs, in which (synthetic) air is used as an oxidizing gas. The professional community currently rejects the use of higher oxygen contents in the oxidation gas of FIDs, as this is expected to be accompanied by an excessive increase in the flame temperature and thus damage to the FID. For example, see DE19653346 which recommends avoiding an oxygen content higher than 50 vol % oxygen. The content of helium provided according to the present invention, however, helps control the temperature of the equipment to acceptably low values and to exploit the advantages of higher oxygen contents.

Without being bound by theory, the higher oxygen concentration used according to the present invention as compared to (synthetic) air increases the ionization rate in the FID flame and the helium content can keep the FID housing temperature in an acceptable range. In some configurations the fume outlet temperature of the FID even dropped, according to the present invention, as compared to normal synthetic air. No detector damage was observed.

Advantageously, the oxidizing gas comprises at least one (further) inert gas, particularly chosen from the group of nitrogen, argon and neon. This reduces the operational costs, since helium is typically expensive. Furthermore, helium is a fossil resource and therefore should be used considerately. As mentioned, as helium causes a considerable drop in temperature, it can be in part be substituted by one or more of the (further) inert gases mentioned.

Preferably, the oxygen content of the oxidizing gas lies between 50 and 80 vol % or 60 and 80 vol %. In this range, the sensitivity is already drastically increased and operational safety can be ensured. Particularly, temperatures can be kept in a safe range using an oxidizing gas comprising the preferable oxygen content indicated.

Another possible composition comprises oxygen in an amount corresponding to 50 to 90 vol % of the oxidizing gas and helium in an amount corresponding to at least 10 vol % of the oxidizing gas. But the amount of oxygen should not be below 50 vol %, evens so first smaller effects could be noted starting from 30 vol %.

The carrier gas preferably comprises helium and/or nitrogen and/or argon and/or neon and/or hydrogen. This aids in further temperature control and does not compromise sensitivity of the measurement of the produced ions.

In the arrangement comprising a flame ionization detector provided according to the present invention, gas supplies adapted to provide a hydrogen containing fuel gas and an oxygen containing oxidizing gas, a burner adapted to burn the fuel gas with the oxidizing gas, producing a flame, a sampler adapted to provide a sample gas containing at least one organic compound and a carrier gas to the flame, producing and an at least partially ionized sample gas, is provided. The flame ionization detector is adapted to measure a current induced by the at least partially ionized sample gas in an electrode of the flame ionization detector.

According to the present invention, the gas supply adapted to provide the oxygen containing oxidizing gas is adapted to provide the oxidizing gas with oxygen in an amount corresponding to between 50 and 90 vol % of the oxidizing gas and helium in an amount corresponding to at least 10 vol % of the oxidizing gas, either by at least in part pre-mixing the oxidizing gas or by withdrawing the oxidizing gas from a storage system or unit which may also form part of the arrangement.

The gas mixture for use in a flame ionization detector is adapted to be used as an oxidizing gas in the flame ionization detector and comprises oxygen in an amount corresponding to between 50 and 90 vol % of the oxidizing gas and helium in an amount corresponding to at least 10 vol % of the oxidizing gas. In each case, the oxidizing gas preferably contains less than 0.1 ppm of hydrocarbons in CH₄ equivalents.

Further advantages and embodiments of the invention will become evident from the appended drawings in relation to the respective description.

It is to be understood that the features discussed previously as well as hereinbelow are not solely useable in the respectively mentioned combinations but may also be used alone or in different combinations without departing from the scope of the current invention as defined in the claims.

In an alternative less effective example, a FID was operated using hydrogen as a fuel gas and a mixture of oxygen in helium as oxidizing gas. In that embodiment, an improvement of the LoD by a factor of 3 to 10 in comparison to conventional operation could be observed. In this further alternative embodiment, about 40 vol % of oxygen in helium could be demonstrated to be a particularly advantageous concentration.

In a further alternative less effective example, a GC-FID was operated using hydrogen as fuel gas, a mixture of oxygen in nitrogen as the oxidizing gas and helium as make-up gas or carrier gas, and an improvement of the LoD by a factor 2 to 8, as compared to conventional operation, could be observed. In this further alternative embodiment, 40 vol % of oxygen in nitrogen and pure helium as make-up gas could be demonstrated to be a particularly advantageous concentration.

In a further alternative less effective example, a FID was operated using 40 vol % hydrogen in helium as fuel gas and a mixture of oxygen in nitrogen as oxidizing gas, and an improvement of the LoD by a factor of 2 to 8 was observed. In this further alternative embodiment, 40 vol % of oxygen in nitrogen could be demonstrated to be a particularly advantageous concentration.

In all of these alternative examples, the actually observed improvement of the LoD depends on the FID used and the analysed organic components. The temperature inside the FID in each case was in an acceptable range and the FID was not damaged.

Total hydrocarbon analyzers as mentioned at the outset are often fueled with a helium/hydrogen mixture containing 60 vol % of helium and 40 vol % of hydrogen. In this configuration, a gas composition proposed according to the invention and according to alternative embodiments is also showing a similar positive effect. The fuel gas flow in is normally much lower as the oxidizer gas flow (factor approx. 1 to 8 or 10) and the cooling effect of the helium content in the fuel gas is conventionally not high enough to keep the detector in a save temperature range.

Some GC-FIDs are using a so-called make-up gas to speed up the transport of the separated hydrocarbon components from the column outlet into the detector. As the flow rate of the helium make-up gas is limited, the cooling effect of the helium is not high enough using an oxidizing gas in the FID without helium.

In the latter cases, the present invention and embodiments thereof, due to the helium content of the oxidizing gas mixture, provide significant advantages.

The invention is illustrated according to an exemplary embodiment in the drawing and described in the following with reference to the drawing.

### SHORT DESCRIPTION OF THE FIGURES

FIG. 1 schematically shows a flame ionization detector which can be used in advantageous embodiments of the invention.

FIG. 2 illustrates an increase in sensitivity of an exemplary FID, achievable using embodiments of the invention.

### EMBODIMENTS OF THE INVENTION

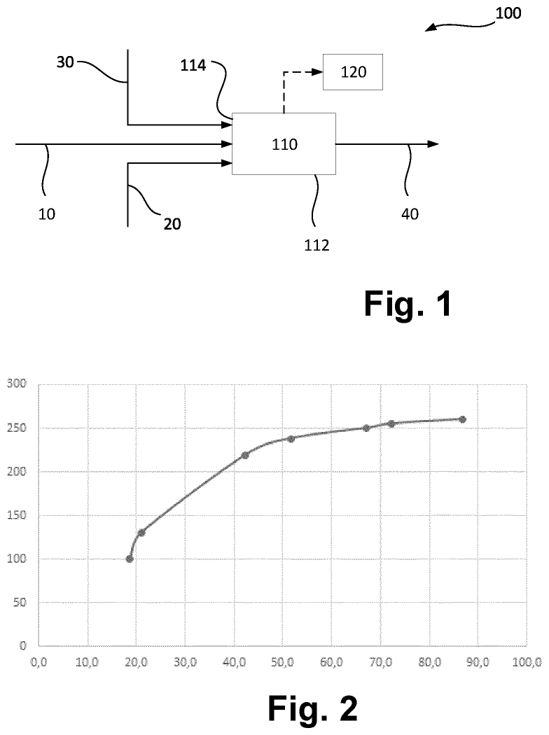

In FIG. 1, a flame ionization detector (FID), which can be used in conjunction with the present invention, is schematically depicted and collectively referred to with 100.

The FID 100 comprises a combustion chamber 110 in which a fuel gas 20, e.g. hydrogen, and an oxidizing gas 30, e.g. a mixture of oxygen, helium and optionally additional inert gas components, is burnt to produce a flame. A sample gas 10 containing at least one organic compound to be analysed is fed to the combustion chamber 110 to be ionized at least partially by the flame.

An electrode 114 is provided at an entrance of the combustion chamber 110. This electrode 114 is particularly configured as a cathode, i.e. during operation of the FID 100 it is negatively polarized. A counter electrode 112, particularly configured as an anode, i.e. positively polarized, is provided along a side wall of the combustion chamber 110, such that cations formed from the at least one organic compound in the sample gas 10 are accelerated towards the electrode 112 and upon hitting the electrode 112 induce a current which is in turn measured or otherwise registered by a computing unit 120 of the FID.

In FIG. 2, a dependence between the sensitivity of an FID and an oxygen content of the oxidizing gas is illustrated. The oxygen content is given on the abscissa in vol %, whereas the ordinate shows the relative sensitivity (normalized to 100% for the lowest value with synthetic air). It can be seen that after a rapid increase in sensitivity with increasing oxygen content, the sensitivity reaches a plateau at about 60% oxygen content. An increase beyond 85% oxygen content does not contribute to a substantial further increase in sensitivity. Furthermore, it is to be noted, that a minimum content in helium is required for temperature control reasons, as mentioned above.

The concrete function of sensitivity in dependence on oxygen content in the oxidizing gas further depends on the device used, flow rates of fuel gas, oxidizing gas and sample gas and also on the specific type of organic compounds to be analysed (e.g. aldehydes may have a slightly different sensitivity profile as compared to ethers and so forth), but generally exhibits a similar trend.

In the example shown in FIG. 2, the values summarized in Table 1 below were obtained for different oxygen fractions.

TABLE 1

| O2 vol % | relative sensitivity % |
|---|---|
| 18.7 | 100 |
| 21.0 | 130 |
| 42.3 | 219 |
| 51.6 | 238 |
| 67.0 | 250 |
| 72.3 | 255 |
| 86.7 | 260 |

1. A method of operating a flame ionization detector comprising:
providing a hydrogen containing fuel gas,
providing an oxygen containing oxidizing gas,
burning the fuel gas with the oxidizing gas to produce a flame,
providing a sample gas to the flame to produce an at least partially ionized sample gas, wherein the sample gas contains at least one organic compound and a carrier gas, and
measuring a current induced by the at least partially ionized sample gas in an electrode of the flame ionization detector,
wherein
the oxidizing gas comprises oxygen in an amount of 50 to 90 vol % of the oxidizing gas and helium in an amount of at least 10 vol % of the oxidizing gas.

2. The method according to claim 1, wherein the oxidizing gas comprises at least one inert gas.

3. The method according to claim 2, wherein the at least one inert gas is selected from the group of nitrogen, argon and neon.

4. The method according to claim 1, wherein the oxygen content of the oxidizing gas lies between 60 and 80 vol %.

5. The method according to claim 1, wherein the carrier gas comprises helium and/or nitrogen and/or argon and/or neon and/or hydrogen.

6. A measuring arrangement adapted to measure a hydrocarbon content of a gas mixture including a flame ionization detector, the arrangement comprising:
a first gas supply adapted to provide a hydrogen containing fuel gas,
a second gas supply adapted to provide an oxygen containing oxidizing gas,
a burner adapted to burn the fuel gas with the oxidizing gas to produce a flame, and
a sampler adapted to provide a sample gas and a carrier gas to the flame to produce an at least partially ionized sample gas, the sample gas containing at least one organic compound,
wherein
the second gas supply is adapted to provide the oxidizing gas with oxygen in an amount from 50 to 90 vol % of the oxidizing gas and helium in an amount of at least 10 vol % of the oxidizing gas.

7. The measuring arrangement of claim 6, wherein the second gas supply is adapted to provide the oxidizing gas by at least in part pre-mixing the oxidizing gas or by withdrawing the oxidizing gas from a storage system or unit.

8. A gas mixture for use in a flame ionization detector adapted to be used as an oxidizing gas in the flame ionization detector, characterized in that the gas mixture comprises oxygen in an amount corresponding to between 50 and 90 vol % of the oxidizing gas and helium in an amount corresponding to at least 10 vol % of the oxidizing gas.

9. The gas mixture of claim 8, containing less than 0, 1 ppm of hydrocarbons in CH4 equivalents.
